(19) United States
(12) Patent Application Publication
(10) Pub. No.: US 2024/0405962 A1
(43) Pub. Date: Dec. 5, 2024

(54) SWITCHING POINTS BETWEEN SUB-BAND FULL DUPLEX (SBFD) AND NON-SBFD SYMBOLS

(71) Applicant: QUALCOMM Incorporated, San Diego, CA (US)

(72) Inventors: Yan ZHOU, San Diego, CA (US); Qian ZHANG, Basking Ridge, NJ (US)

(21) Appl. No.: 18/329,393

(22) Filed: Jun. 5, 2023

(51) Int. Cl. H04L 5/14

(52) U.S. Cl. CPC H04L 5/1438

(57) ABSTRACT

Certain aspects of the present disclosure provide a method for wireless communications at a user equipment (UE). The UE may transmit an indication of a limit on a number of switching points (or transition points) between one or more first symbols configured for sub-band full duplex (SBFD) communications and one or more second symbols configured for non-SBFD communications, within a period of time. The UE may receive a configuration for the SBFD communications, which is in accordance with the indication.

### BACKGROUND

### Field of the Disclosure

Aspects of the present disclosure relate to wireless communications, and more particularly, to techniques for supporting full duplex (FD) communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes determining a limit on a number of switching points between one or more first symbols configured for sub-band full duplex (SBFD) communications and one or more second symbols configured for non-SBFD communications, within a period of time; determining a configuration for the SBFD communications based on the limit; and performing the SBFD communications, in accordance with the configuration.

Another aspect provides a method for wireless communications at a network entity. The method includes determining a limit on a number of switching points between one or more first symbols configured for SBFD communications and one or more second symbols configured for non-SBFD communications, within a period of time; and transmitting a configuration for the SBFD communications based on the determination.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5, FIG. 6, FIG. 7, and FIG. 8 depict different use cases for full-duplex (FD) communications.

FIG. 9 depicts example FD operation at a gNodeB (gNB).

FIG. 10A and FIG. 10B depict example sub-band full duplex (SBFD) slots.

FIG. 11 and FIG. 12 depict example slots that consist of both SBFD and non-SBFD symbols.

FIG. 13 and FIG. 14 depict call flow diagrams illustrating example communication among a UE and a network entity.

FIG. 15 depicts a method for wireless communications at a UE.

FIG. 16 depicts a method for wireless communications at a network entity.

FIG. 17 and FIG. 18 depict example communications devices.

### DETAILED DESCRIPTION

Full duplex (FD) communication generally refers to a mode of communication where signals can be transmitted and received simultaneously over a single communication channel. In an FD mode, simultaneous transmission between wireless nodes (e.g., a user equipment (UE) and a base station (BS)) may occur. Sub-band full duplex (SBFD) generally refers to a mode where a time division duplex (TDD) carrier is split into sub-bands to enable simultaneous transmission and reception (on different subbands) in a same slot that consists of multiple symbols.

In some cases, a slot may include both SBFD symbols and non-SBFD symbols. In such cases, frequent switching may be needed between the SBFD symbols and the non-SBFD symbols during uplink (UL)/downlink (DL) transmission/reception. For example, the UE may have to transmit a first UL signal during the SBFD symbols of the slot and a second UL signal during the non-SBFD symbols of the slot. However, switching may be required because of different filters and radio frequency (RF) tuning requirements for operations during the SBFD symbols and the non-SBFD symbols. Such different requirements may increase the hardware implementation complexity (e.g., due to use of the different filters) as well as cause interruptions of transmissions/receptions during the transition between the SBFD symbols and the non-SBFD symbols.

To reduce the frequent switching between the SBFD symbols and the non-SBFD symbols, aspects of the present disclosure provide mechanisms for defining a maximum number of switching points between the SBFD symbols and the non-SBFD symbols (or transition points from the SBFD symbols to the non-SBFD symbols) within a period (e.g., the slot). For example, a BS may configure a UE with the maximum number of switching points between the SBFD symbols and the non-SBFD symbols, which may be determined by the BS based on UE capability and/or a rule. The UE then performs SBFD communications, in accordance with its configuration.

Particular aspects of the subject matter described in this disclosure can be implemented to realize one or more of the following potential advantages. In some examples, the described techniques can be used to improve resource utilization and reduce latency (e.g., since the SBFD mode allows the UE to transmit UL signal in UL subband in DL only or flexible slots or receive DL signal in DL subband(s) in legacy UL only slots). Additionally, a limit on a number of switching points between the SBFD symbols and the non-SBFD symbols within the slot may reduce the frequent switching between the SBFD symbols and the non-SBFD symbols, which may further prevent or reduce the interruptions of the transmissions/receptions within the slot.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

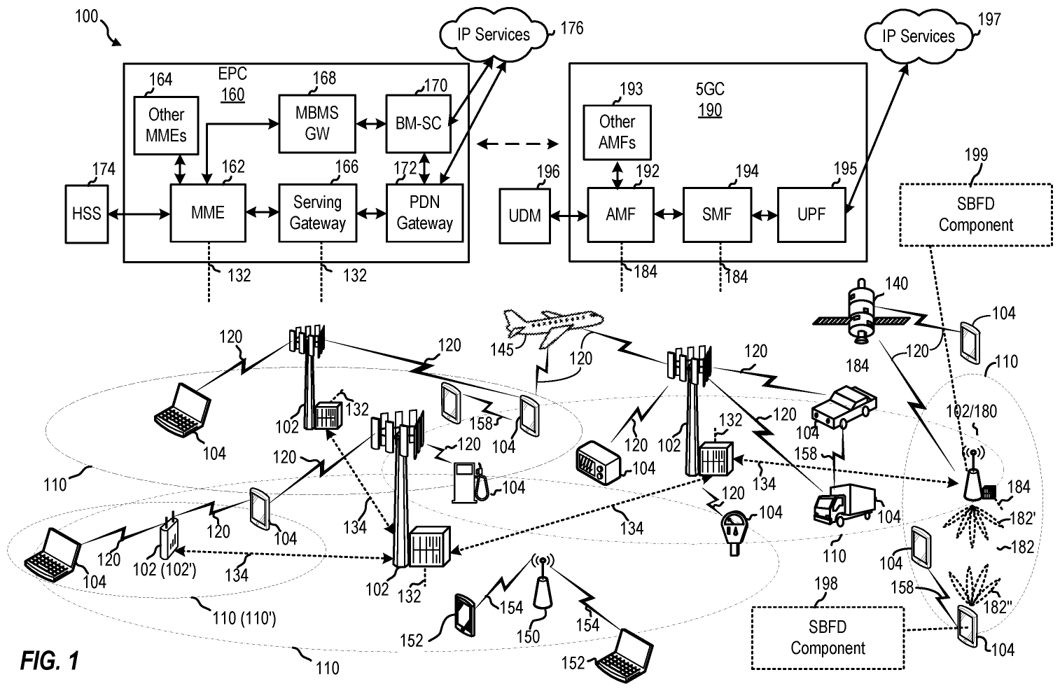

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

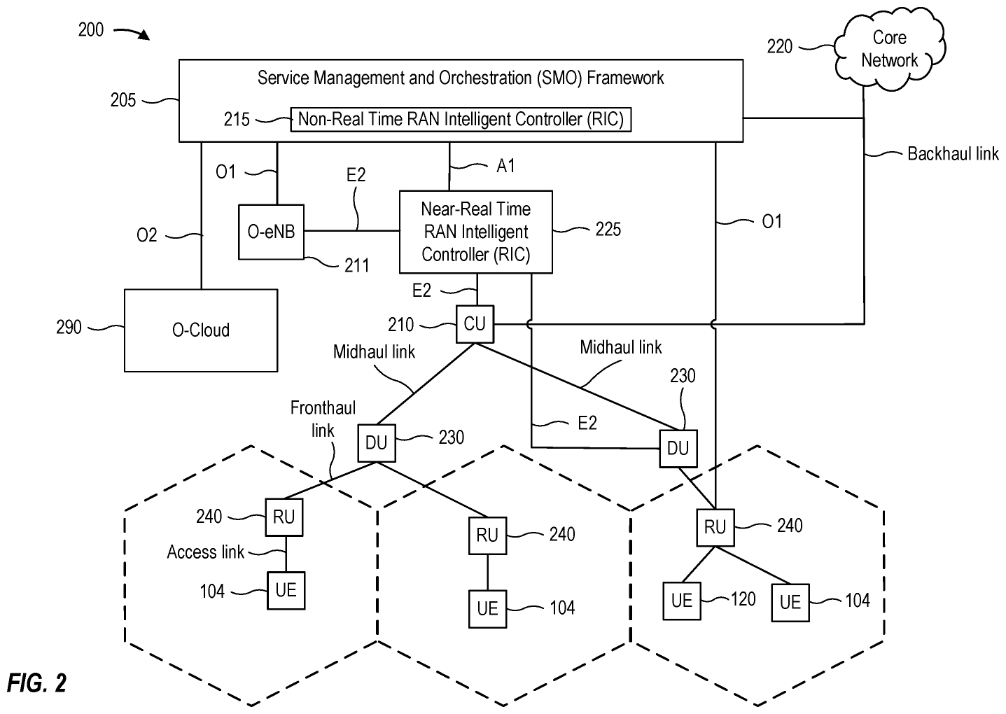

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

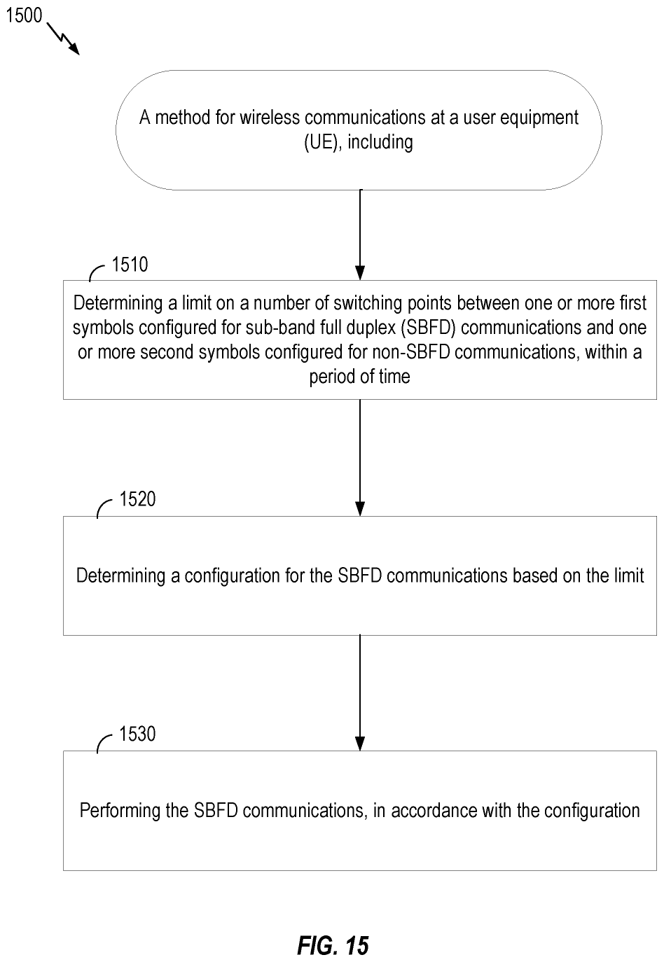

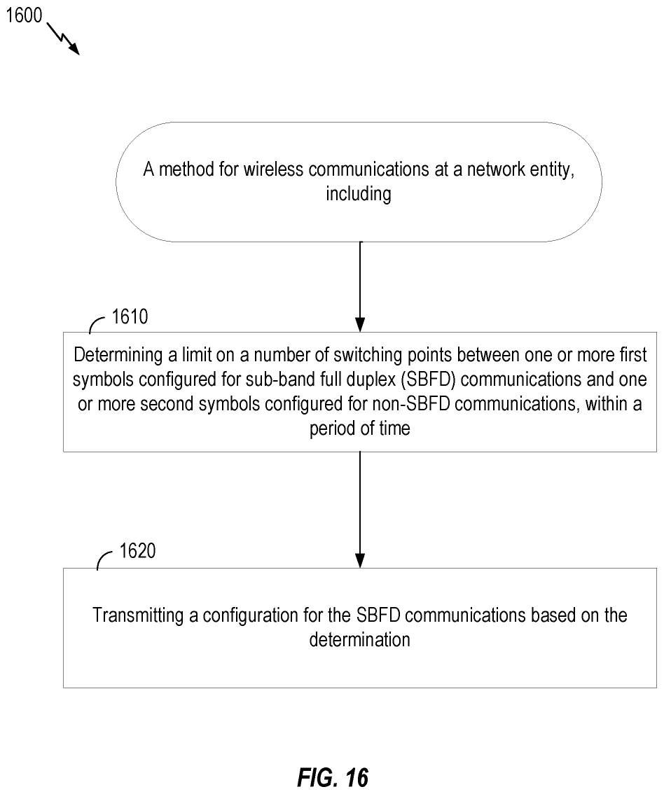

Wireless communication network 100 further includes sub-band full duplex (SBFD) component 198, which may be configured to perform method 1500 of FIG. 15. Wireless communication network 100 further includes SBFD component 199, which may be configured to perform method 1600 of FIG. 16.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

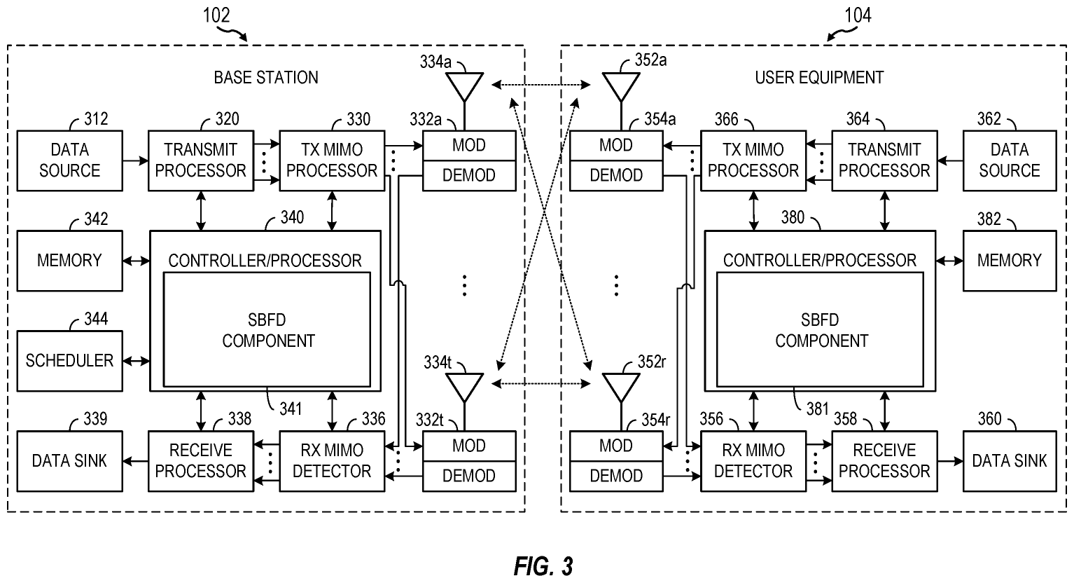

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes SBFD component 341, which may be representative of SBFD component 199 of FIG. 1. Notably, while depicted as an aspect of controller/processor 340, SBFD component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SBFD component 381, which may be representative of SBFD component 198 of FIG. 1. Notably, while depicted as an aspect of controller/processor 380, SBFD component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

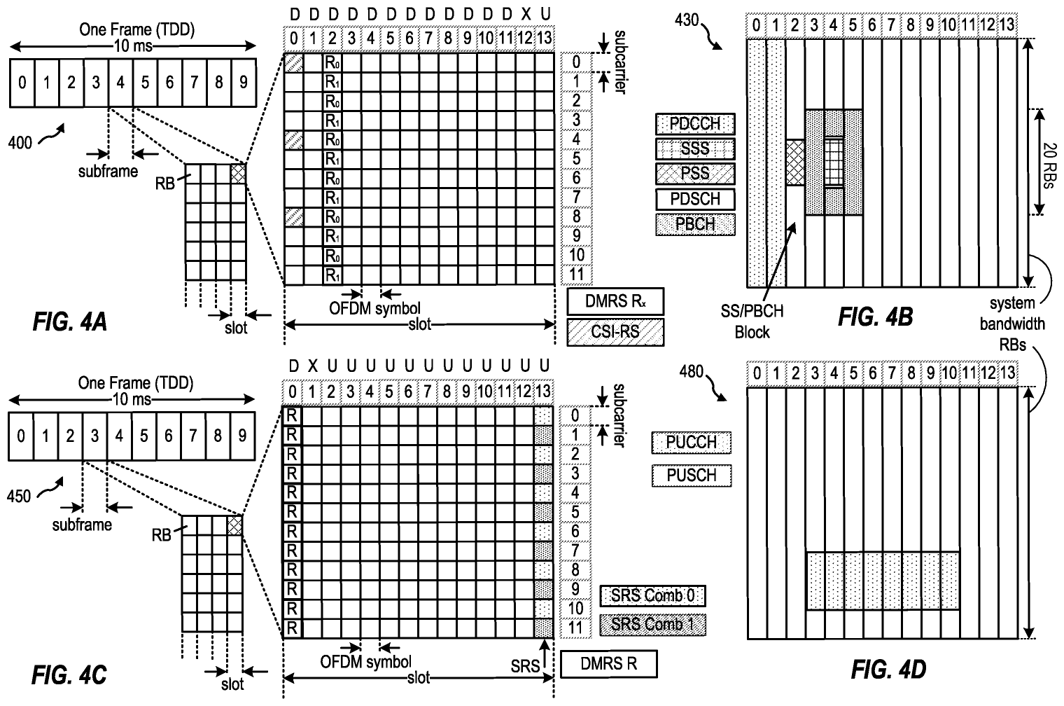

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mm Wave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHZ-6 GHZ, though specific uplink and downlink allocations may fall outside of this general range. Thus, FR1 is often referred to (interchangeably) as a “Sub-6 GHz” band.

Similarly. TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHZ-300 GHZ) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Full-Duplex (FD) Systems

Full-duplex (FD) allows for simultaneous transmission between nodes (e.g., a user equipment (UE) and a base station (BS)). In a half-duplex (HD) system, communication flows in one direction at a time.

There are various motivations for utilizing FD communications, for example, for simultaneous uplink (UL)/downlink (DL) transmissions in Frequency Range 2 (FR2). In some cases, FD capability may enable flexible time division duplexing (TDD) capability, and may be present at either a base station (BS) or a UE or both. For example, at the UE, UL transmissions may be sent from one antenna panel (e.g., of multiple antenna panels) and DL receptions may be performed at another antenna panel. In another example, at a gNodeB (gNB), the UL transmissions may be from one panel and the DL receptions may be performed at another panel.

The FD capability may be conditional on a beam separation (e.g., self-interference between DL and UL, clutter echo, etc.). The FD capability may mean that the UE or the gNB is able to use frequency division multiplexing (FDM) or spatial division multiplexing (SDM) on slots conventionally reserved for UL only or DL only slots (or flexible slots that may be dynamically indicated as either UL or DL).

The potential benefits of the FD communications include latency reduction (e.g., it may be possible to receive DL signals in what would be considered UL only slots, which can enable latency savings), coverage enhancement, spectrum efficiency enhancements (per cell and/or per UE), and/or overall more efficient resource utilization.

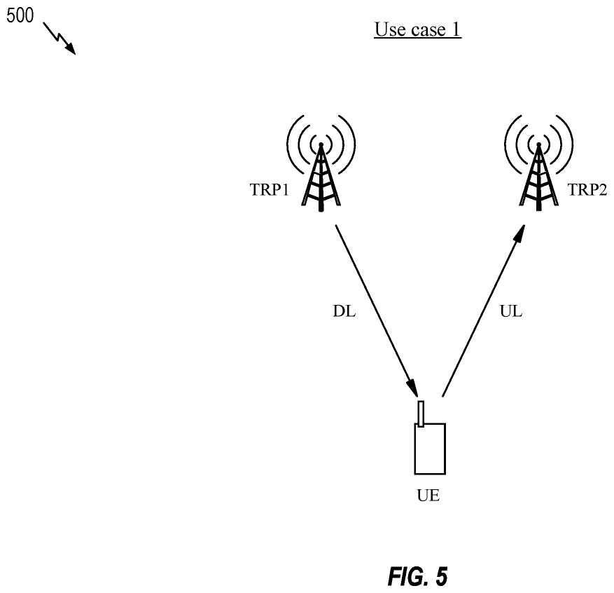

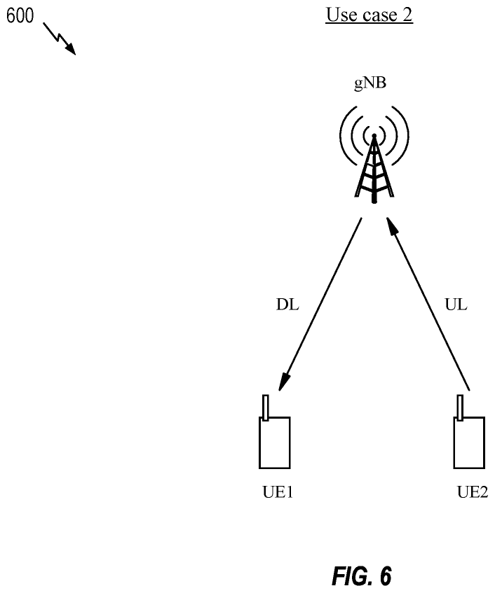

FIG. 5. FIG. 6, and FIG. 7 illustrate example use cases for FD communications. FIG. 8 summarizes certain possible features of these use cases.

Diagram 500 of FIG. 5 illustrates a first use case (e.g., Use Case 1) for FD communications. As illustrated, one UE simultaneously communicates with a first transmitter receiver point (TRP 1) on DL, while transmitting to a second TRP on UL. For this use case, FD is disabled at a gNB (i.e., TRP 1, TRP 2) and enabled at the UE.

Diagram 600 of FIG. 6 illustrates a second use case (e.g., Use Case 2) for FD communications. As illustrated, one gNB simultaneously communicates with a first UE (UE 1) on DL, while communicating with a second UE (UE 2) on UL. For this use case, FD is enabled at the gNB and disabled at the UEs. Use cases with the FD enabled at the gNB and disabled at the UEs may be suitable for integrated access and backhaul (IAB) applications as well (e.g., as illustrated in a table 800 of FIG. 8).

Diagram 700 of FIG. 7 illustrates a third use case (e.g., Use Case 3) for FD communications. As illustrated, a UE simultaneously communicates with a gNB, transmitting on UL while receiving on DL. For this use case, FD is enabled at both the gNB and the UE.

### Overview of Sub-band Full Duplex (SBFD)

As compared to older communication standards, spectrum options for 5G new radio (NR) are considerably expanded. For example, a frequency range 2 (FR2) band extends from approximately 24 GHz to 60 GHz. Since the wavelength decreases as the frequency increases, the FR2 band is denoted as a millimeter wave band due to its relatively-small wavelengths. In light of this relatively short wavelength, the transmitted radio frequency (RF) signals in the FR2 band behave somewhat like visible light. Thus, just like light, millimeter-wave signals are readily shadowed by buildings and other obstacles. In addition, the received power per unit area of antenna element goes down as the frequency goes up. For example, a patch antenna element is typically a fraction of the operating wavelength (e.g., one-half of the wavelength) in width and length. As the wavelength goes down (and thus the size of the antenna element decreases), it may thus be seen that the signal energy received at the corresponding antenna element decreases. Millimeter-wave cellular networks will generally require a relatively-large number of base stations (BSs) due to the issues of shadowing and decreased received signal strength. A cellular provider must typically rent the real estate for the BSs such that widespread coverage for a millimeter-wave cellular network may become very costly.

As compared to the challenges of FR2, the electromagnetic properties of radio wave propagation in the sub-6 GHz bands are more accommodating. For example, the 5G NR frequency range 1 (FR1) band extends from approximately 0.4 GHz to 7 GHz. At these lower frequencies, the transmitted RF signals tend to refract around obstacles such as buildings so that the issues of shadowing are reduced. In addition, the larger size for each antenna element means that a FR1 antenna element intercepts more signal energy as compared to an FR2 antenna element. Thus, just as was established for older networks, a 5G NR cellular network operating in the FR1 band will not require an inordinate amount of BSs. Given the favorable properties of the lower frequency bands, the sub-6 GHz bands are often denoted as “beachfront” bands due to their desirability.

One issue with operation in the sub-6 GHz bands is that there is only so much bandwidth available. For this reason, Federal Communications Commission regulates the airwaves and conducts auctions for the limited bandwidth in the FR1 band. Given this limited bandwidth, it is challenging for a cellular provider to enable the high data rates that would be more readily achieved in the FR2 band. To meet these challenges, a “sub-band full duplex” (SBFD) network architecture is implemented, which is quite advantageous as it offers users the high data rates that would otherwise require usage of the FR2 band. The SBFD network architecture described herein provides the high data rates in the FR1 band, and thus lowers costs due to the smaller number of BSs per given area of coverage that may be achieved in the FR1 band as compared to the FR2 band.

Typically, each one millisecond (ms) subframe may consist of one or multiple adjacent slots. For example, one subframe includes four slots. In a four-slot structure, first two slots may be downlink (DL) slots whereas a final one of the fours slots is an uplink (UL) slot. The third slot is a special slot in which some symbols may be used for UL transmissions and others for DL transmissions. The resulting UL and DL traffic is thus time division duplexed (TDD) as arranged by the dedicated slots and as arranged by the symbol assignment in the special slot. Since the UL has only a single dedicated slot, UL communication may suffer from excessive latency since a user equipment (UE) is restricted to transmitting in the single dedicated UL slot and in the resource allocations within the special slot. Since there is only one dedicated UL slot in the repeating four-slot structure, the resulting latency can be problematic particularly for low-latency applications such as vehicle-to-vehicle communication. In addition, the energy for the UL communication is limited by its single dedicated slot.

To reduce uplink latency and increase the energy for the UL transmissions, SBFD mode may be implemented. The SBFD mode is a duplex mode with a TDD carrier split into sub-bands to enable simultaneous transmission and reception in same slots. For example, in the SBFD mode, some slots are modified as SBFD slots to support frequency duplexing for simultaneous UL and DL transmissions. Some slots may remain as legacy TDD slots where one slot is still dedicated to DL and another slot dedicated to UL. In one example four-slot structure, in the SBFD mode, the second and third slots may be SBFD slots modified to support frequency duplexing for simultaneous UL and DL transmissions. The first slot and the fourth slot may remain as legacy TDD slots such that the first slot is still dedicated to DL and the fourth slot dedicated to UL. In other examples, any slot may be used in the SBFD mode.

In the sub-6 GHz spectrum, the relatively-limited separation between antennas on a device will lead to substantial self-interference should the device engage in a simultaneous UL and DL transmission. In some cases, the frequency duplexing in the SBFD slots may be practiced by a BS transceiver.

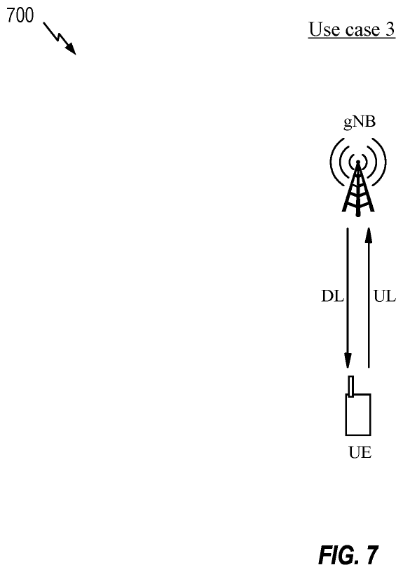

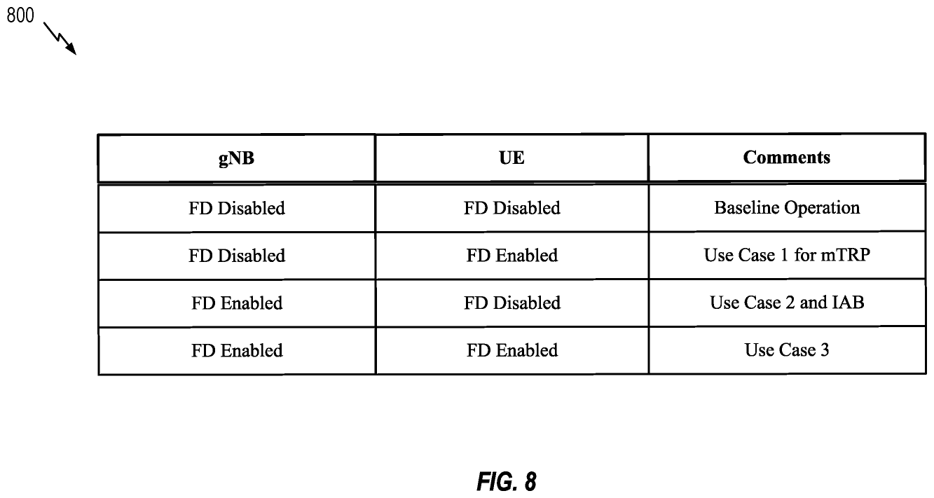

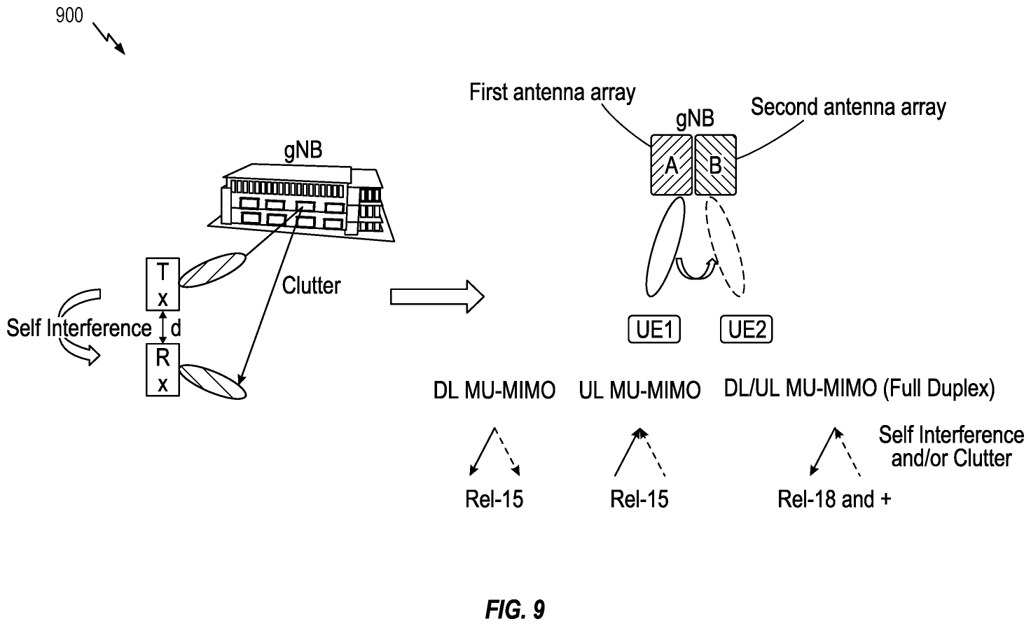

For example, diagram 900 of FIG. 9 depicts full-duplex (FD) operation at a gNodeB (gNB). An antenna system for the gNB is subdivided into a first antenna array that is separated from a second antenna array by an insulating distance such as, for example, 10 to 30 cm. During the SBFD operation, one of the antenna arrays transmits (e.g., to a first UE (UE1)) while the other antenna array is receiving (e.g., from a second UE (UE2)). The self-interference problem is partially addressed by a physical separation between the antenna arrays of the gNB. To provide additional isolation, a conducting shield between the antenna arrays of the gNB may also be implemented. It will be appreciated, however, that frequency duplexing may also be practiced by the device (or more generally, a UE) should the device practice sufficient self-interference cancellation. In other cases, however, the UE may be limited to half-duplex (HD) transmission such that the UE's antenna array is entirely dedicated to just transmitting or to just receiving in respective slots.

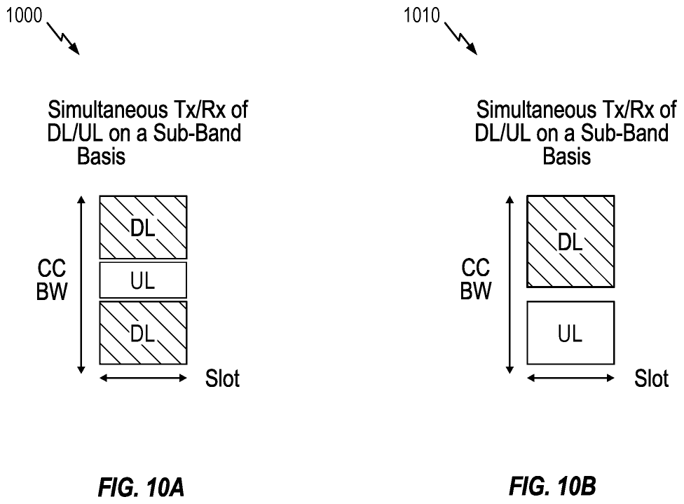

Example SBFD slots are depicted in FIG. 10A and FIG. 10B. For example, FIG. 10A depicts SBFD slot 1000 and FIG. 10B depicts SBFD slot 1010. Note that neither the UL nor the DL in the SBFD slots 1000, 1010 may occupy an entire frequency resource range (e.g., a frequency band) for these SBFD slots.

As depicted in FIG. 10A, the UL occupies a central sub-band in the frequency band for the SBFD slot 1000. The DL occupies a lower sub-band that ranges from a lower frequency for the frequency band up to a lowest frequency for the UL central sub-band. In some cases, the sub-bands may be separated by a guard band. The DL also occupies an upper sub-band in the frequency band and extends from a greatest frequency for the UL central sub-band to a greatest frequency for the frequency band. In one example, the UL central sub-band may be symmetric about a center frequency for the SBFD slot 1000. In such example, the bandwidth for the DL lower sub-band and the DL upper sub-band would be equal. However, in other examples, the DL lower sub-band bandwidth may be different from the bandwidth for the DL upper sub-band. In some examples, the DL upper and lower sub-bands may each have the bandwidth that may vary as 10 MHZ, 20 MHZ, 30 MHz or 40 MHz depending upon a DL data rate.

The use of the SBFD slot is advantageous with regard to minimizing or reducing UE-to-UE interference and transmit-to-receive self-interference at a BS. In some cases, the use of the SBFD slot may also enhance system capacity, improve resource utilization and spectrum efficiency (e.g., by enabling flexible and dynamic UL/DL resource adaption according to UL/DL traffic in a robust manner).

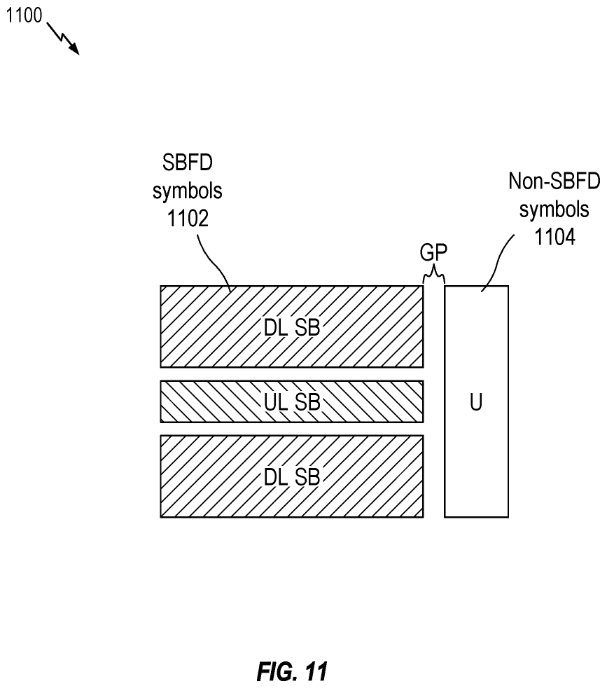

FIG. 11 depicts one example slot 1100 for legacy TDD and SBFD communication. As depicted, the slot 1100 includes both SBFD and non-SBFD symbols (e.g., in accordance with symbol-level TDD UL/DL configuration). For example, in the slot 1100, DL symbols 1102 can be configured as SBFD symbols followed by guard symbols and then UL symbols (e.g., non-SBFD symbols) 1104 at the end.

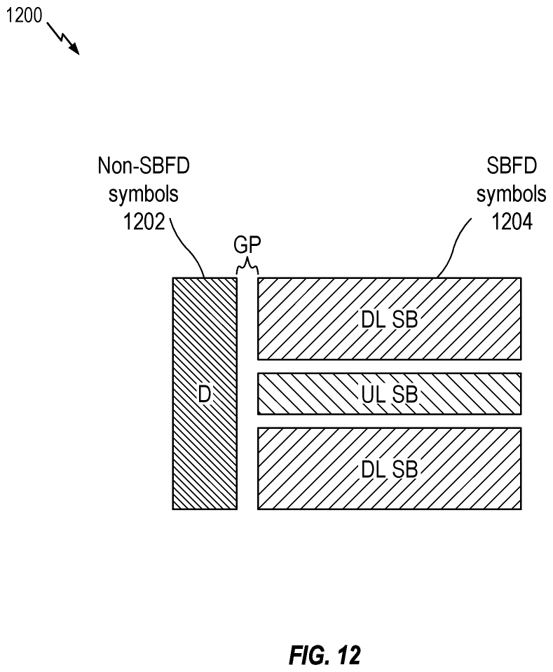

FIG. 12 depicts another example slot 1200 for legacy TDD and SBFD communication. As depicted, the slot 1200 also includes both SBFD and non-SBFD symbols (e.g., in accordance with symbol-level TDD UL/DL configuration). For example, in the slot 1200, initial one or more symbols may be DL symbols (e.g., non-SBFD symbols) 1202 followed with guard symbols and then remaining DL symbols 1204 can be configured (e.g., semi-static configured) as SBFD symbols.

In some cases, when the slot includes both SBFD and non-SBFD symbols, frequent switching between the SBFD symbols and the non-SBFD symbols during UL/DL transmission/reception operation may be needed. For example, a UE may have to transmit a first UL signal during the SBFD symbols of the slot and a second UL signal during the non-SBFD symbols of the slot. However, the UE is unable to uninterruptedly transition between the SBFD symbols and the non-SBFD symbols of the slot to perform the UL transmissions. This is because of different filters and radio frequency (RF) tuning requirements for operations during the SBFD symbols and the non-SBFD symbols of the slot. Such different requirements may increase the hardware implementation complexity (e.g., due to use of the different filters) as well as cause interruptions of transmissions/receptions during the transition between the SBFD symbols and the non-SBFD symbols of the slot.

In some cases, a guard period may be needed between the SBFD symbols and the non-SBFD symbols of the slot to allow for the transition between the SBFD symbols and the non-SBFD symbols of the slot. In some cases, a length of the guard period may also have a limited value.

### Aspects Related to Defining a Number of Switching Points Between Sub-Band Full Duplex (SBFD) And Non-SBFD Symbols

Aspects of the present disclosure provide apparatuses, methods, processing systems, and computer-readable mediums for defining a maximum number of switching points between sub-band full duplex (SBFD) symbols and non-SBFD symbols (or transition points from the SBFD symbols to the non-SBFD symbols) within a period (e.g., a slot).

For example, a base station (BS) may configure a user equipment (UE) with the maximum number of switching points (or transition points) between the SBFD symbols and the non-SBFD symbols within the slot. In some cases, this number may be determined by the BS based on UE capability and/or a rule. The UE performs SBFD communications, in accordance with its configuration.

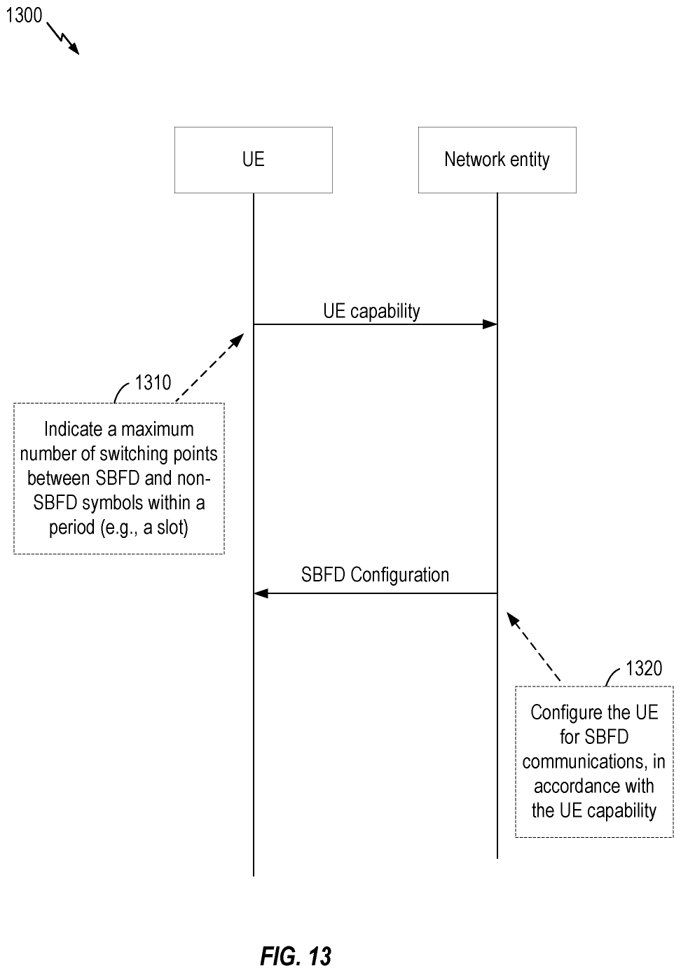

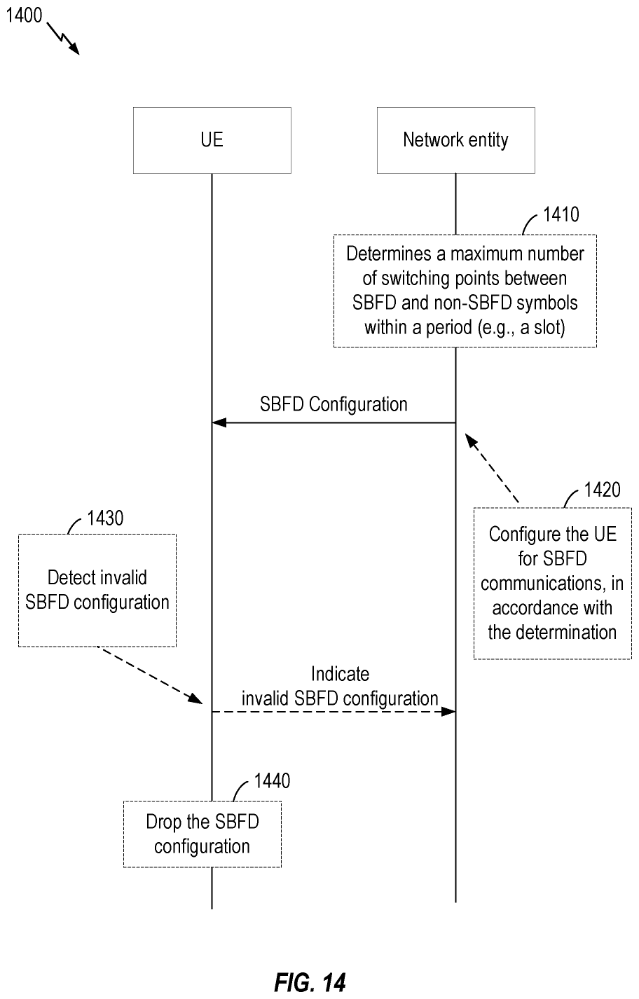

The techniques proposed herein for defining a number of switching points or transition points between the SBFD symbols and the non-SBFD symbols may be understood with reference to FIG. 13, FIG. 14, FIG. 15, and FIG. 16.

FIG. 13 depicts a call flow diagram 1300 illustrating example communication among a UE and a network entity for managing switching points or transition points between SBFD symbols and non-SBFD symbols. The UE shown in FIG. 13 may be an example of the UE 104 depicted and described with respect to FIG. 1 and FIG. 3. The network entity depicted in FIG. 13 may be an example of the BS 102 depicted and described with respect to FIG. 1 and FIG. 3, or the disaggregated BS depicted and described with respect to FIG. 2.

As indicated at 1310, the UE may transmit an indication of the UE capability to the network entity (e.g., in a UE capability report). The UE capability may indicate a maximum number of switching points between the SBFD symbols and the non-SBFD symbols within a period. In certain aspects, the SBFD symbols support frequency duplexing for simultaneous UL and DL transmissions.

In one example, the period may include a slot. In another example, the period may include a time division duplex (TDD) UL and DL pattern period. The TDD UL and DL pattern period may indicate a duration of time (e.g., 5 milliseconds (5 ms)) or a consecutive number of slots (e.g., 5 slots). In another example, the period may include a semi-static SBFD configuration period. The semi-static SBFD configuration period may include one or more slots, which are semi-static configured by the network entity. A periodicity of the TDD UL and DL pattern period may be same or different than a periodicity of the semi-static SBFD configuration period.

In certain aspects, the UE capability may indicate one or more new capabilities on the maximum number of switching points between the SBFD symbols and the non-SBFD symbols within the period per subcarrier spacing (SCS).

For example, the UE capability may indicate N number of switching points between the SBFD symbols and the non-SBFD symbols within the period on a first SCS (e.g., 30 KHz). In another example, the UE capability may indicate M number of switching points between the SBFD symbols and the non-SBFD symbols within the period on a second SCS (e.g., 120 KHz). In another example, the UE capability may indicate X number of switching points between the SBFD symbols and the non-SBFD symbols within the period on a third SCS (e.g., 60 KHz). In another example, the UE capability may indicate Y number of switching points between the SBFD symbols and the non-SBFD symbols within the period on a fourth SCS (e.g., 90 KHz). The N number of switching points, the M number of switching points, the X number of switching points, and the Y number of switching points may be different from each other.

In certain aspects, the UE capability may indicate one new reference capability on the maximum number of switching points between the SBFD symbols and the non-SBFD symbols within the period per frequency range (FR).

For example, the UE capability (e.g., for a second FR (FR2)) may indicate S1 number of switching points between the SBFD symbols and the non-SBFD symbols within the period on a first SCS (e.g., 60 KHz). The number of switching points may be scaled for other SCSs. For instance, there may be S1/2 number of switching points between the SBFD symbols and the non-SBFD symbols within the period on a second SCS (e.g., 120 KHz).

In another example, the UE capability (e.g., for a first FR (FR1)) may indicate S2 number of switching points between the SBFD symbols and the non-SBFD symbols within the period on a third SCS (e.g., 15 KHz), and the number of switching points may be scaled for other SCSs. For instance, S2/2 number of switching points between the SBFD symbols and the non-SBFD symbols within the period on a fourth SCS (e.g., 30 KHz).

As indicated at 1320, the network entity configures the UE with SBFD configuration for SBFD communications, in accordance with the UE capability. For example, the UE may be configured with a number of switching points between the SBFD symbols and the non-SBFD symbols within the period, which is less than or equal to the maximum number.

FIG. 14 depicts another call flow diagram 1400 illustrating example communication among a UE and a network entity for managing switching points or transition points between SBFD symbols and non-SBFD symbols. The UE shown in FIG. 14 may be an example of the UE 104 depicted and described with respect to FIG. 1 and FIG. 3. The network entity depicted in FIG. 14 may be an example of the BS 102 depicted and described with respect to FIG. 1 and FIG. 3, or the disaggregated BS depicted and described with respect to FIG. 2.

As indicated at 1410, the network entity determines a maximum number of switching points between the SBFD symbols and the non-SBFD symbols within a period (e.g., a slot, a TDD UL and DL pattern period, a semi-static SBFD configuration period, etc.).

In one example, the network entity may determine the maximum number of switching points based on a rule (e.g., which may indicate the maximum number of switching points between the SBFD symbols and the non-SBFD symbols within the period). In another example, the network entity may determine the maximum number of switching points based on UE capability (e.g., which may indicate the maximum number of switching points between the SBFD symbols and the non-SBFD symbols within the period) received from the UE.

In certain aspects, a value of the maximum number of switching points between the SBFD symbols and the non-SBFD symbols within the period may be equal to one.

In certain aspects, a value of the maximum number of switching points between the SBFD symbols and the non-SBFD symbols within the period may be equal to two.

In certain aspects, a value of the maximum number of switching points between the SBFD symbols and the non-SBFD symbols within the period may be equal to N where N is an integer.

As indicated at 1420, the network entity configures the UE with SBFD configuration for SBFD communications, in accordance with the maximum number of switching points between the SBFD symbols and the non-SBFD symbols within the period. For example, the UE may be configured with a number of switching points between the SBFD symbols and the non-SBFD symbols within the period, which is less than or equal to the maximum number.

As indicated at 1430, the UE detects that the SBFD configuration is invalid. For example, the UE may be configured (e.g., via the SBFD configuration) with a number of switching points between the SBFD symbols and the non-SBFD symbols within the period, which is more than the maximum number. In such cases, the UE may determine that the SBFD configuration is invalid. In one example, the UE may determine that the SBFD configuration is invalid based on the rule (which may be known to the UE). In another example, the UE may determine that the SBFD configuration is invalid based on the UE capability. Upon detecting the SBFD configuration to be invalid, the UE indicates that the SBFD configuration is invalid to the network entity.

As indicated at 1440, the UE drops the SBFD configuration (e.g., when the UE detects that the SBFD configuration is invalid).

In certain aspects, the TDD UL and DL pattern period may be different than the semi-static SBFD configuration period. In such cases, the UE may not transmit a new UE capability to the network entity (e.g., for the TDD UL and DL pattern period, the semi-static SBFD configuration period). In such cases, the UE may transmit to the network entity information associated with a maximum or a minimum value of the maximum number of switching points between the SBFD symbols and the non-SBFD symbols within the semi-static SBFD configuration period. In such cases, the UE may also transmit to the network entity information associated with a maximum or a minimum value of the maximum number of switching points between the SBFD symbols and the non-SBFD symbols within the TDD UL and DL pattern period.

### Example Method for Wireless Communications at a User Equipment (UE)

FIG. 15 shows an example of a method 1500 for wireless communications at a user equipment (UE), such as the UE 104 of FIG. 1 and FIG. 3.

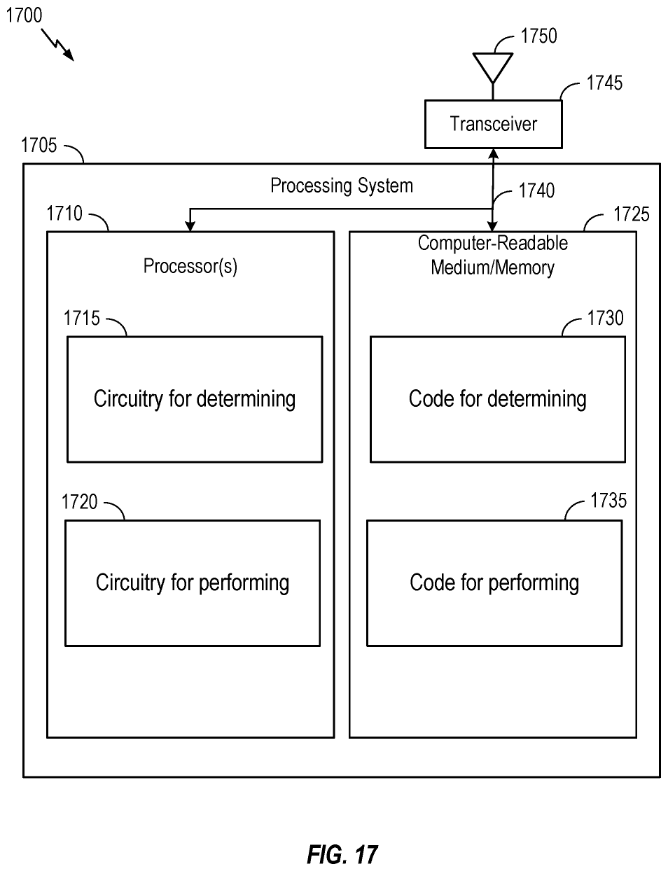

Method 1500 begins at step 1510 with determining a limit on a number of switching points (or transition points) between one or more first symbols configured for sub-band full duplex (SBFD) communications and one or more second symbols configured for non-SBFD communications, within a period of time. In some cases, the operations of this step refer to, or may be performed by, circuitry for determining and/or code for determining as described with reference to FIG. 17.

Method 1500 then proceeds to step 1520 with determining a configuration for the SBFD communications based on the limit. In some cases, the operations of this step refer to, or may be performed by, circuitry for determining and/or code for determining as described with reference to FIG. 17.

Method 1500 then proceeds to step 1530 with performing the SBFD communications, in accordance with the configuration. In some cases, the operations of this step refer to, or may be performed by, circuitry for performing and/or code for performing as described with reference to FIG. 17.

In certain aspects, the method 1500 further includes transmitting an indication of the limit to a network entity.

In certain aspects, the determining the configuration further includes receiving the configuration from the network entity.

In certain aspects, the method 1500 further includes transmitting an indication of invalid configuration when a value of the limit is more than the number of switching points, and wherein the number of switching points is configured by a network entity or based on a rule.

In certain aspects, the method 1500 further includes dropping the configuration when the configuration is invalid.

In certain aspects, the one or more first symbols support subband frequency duplexing for simultaneous uplink (UL) and downlink (DL) transmissions.

In certain aspects, the period of time is associated with: a slot, a time division duplex (TDD) UL and DL pattern period, or a semi-static SBFD configuration period.

In certain aspects, the TDD UL and DL pattern period is different than the semi-static SBFD configuration period. The method 1500 further includes transmitting an indication of a maximum value or a minimum value of at least one of: the limit on the number of switching points between the one or more first symbols and the one or more second symbols within the semi-static SBFD configuration period or the limit on the number of switching points between the one or more first symbols and the one or more second symbols within the TDD pattern period.

In certain aspects, a value of the limit is less than or equal to the number of switching points, and the number of switching points is configured by a network entity or based on a rule.

In certain aspects, a value of the limit is equal to one.

In certain aspects, a value of the limit is equal to two.

In certain aspects, one or more values of the limit are based on one or more values of a subcarrier spacing (SCS). In certain aspects, a first value of the limit is for a first value of the SCS and a second value of the limit is for a second value of the SCS; the first value of the limit is different than the second value of the limit; and the first value of the SCS is different than the second value of the SCS.

In certain aspects, one or more values of the limit are based on one or more values of a frequency range (FR). In certain aspects, a first value of the limit is for a first FR and a second value of the limit is for a second FR; the first value of the limit is different than the second value of the limit; and the first FR is different than the second FR.

In certain aspects, the method 1500 further includes transmitting reference capability indicating a reference value corresponding to the limit per FR, where one or more values of the limit for one or more values of the SCS is based on the reference value.

In one aspect, the method 1500, or any aspect related to it, may be performed by an apparatus, such as a communications device 1700 of FIG. 17, which includes various components operable, configured, or adapted to perform the method 1500. The communications device 1700 is described below in further detail.

Note that FIG. 15 is just one example of a method, and other methods including fewer, additional, or alternative steps are possible consistent with this disclosure.

### Example Method for Wireless Communications at a Network Entity

FIG. 16 shows an example of a method 1600 for wireless communications at a network entity, such as the BS 102 of FIG. 1 and FIG. 3.

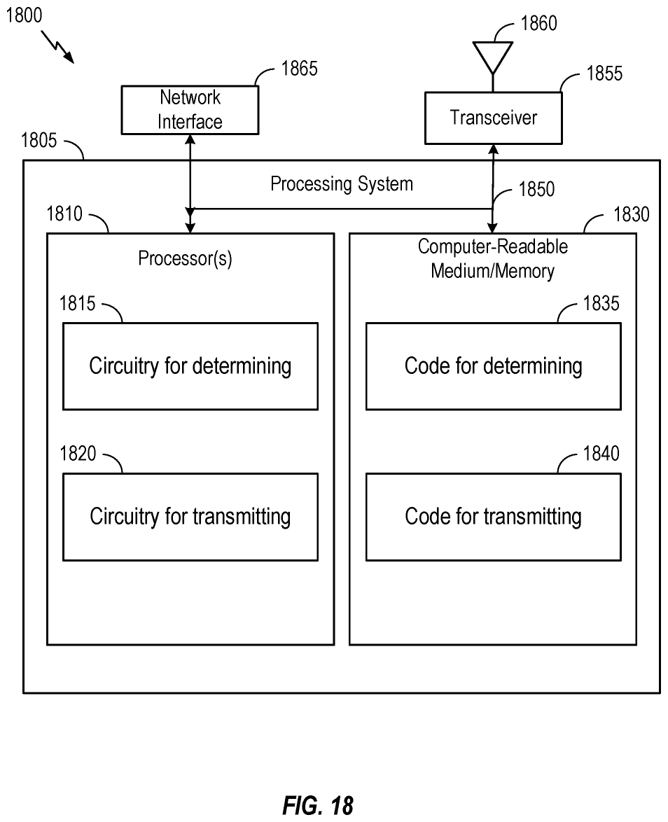

Method 1600 begins at step 1610 with determining a limit on a number of switching points (or transition points) between one or more first symbols configured for sub-band full duplex (SBFD) communications and one or more second symbols configured for non-SBFD communications, within a period of time. In some cases, the operations of this step refer to, or may be performed by, circuitry for determining and/or code for determining as described with reference to FIG. 18.

Method 1600 then proceeds to step 1620 with transmitting a configuration for the SBFD communications based on the determination. In some cases, the operations of this step refer to, or may be performed by, circuitry for transmitting and/or code for transmitting as described with reference to FIG. 18.

In certain aspects, the period of time is associated with: a slot, a time division duplex (TDD) uplink (UL) and downlink (DL) pattern period, or a semi-static SBFD configuration period.

In certain aspects, the determining further includes receiving capability information from a user equipment (UE), and the capability information includes the limit on the number of switching points.

In certain aspects, the determining further includes determining the limit on the number of switching points based on a rule.

In certain aspects, a value of the limit is equal to one or two.

In certain aspects, the one or more first symbols support subband frequency duplexing for simultaneous UL and DL transmissions. The method 1600 further includes transmitting a DL transmission in a DL subband to a UE or receiving an UL transmission in a UL subband from the UE in a same symbol of the one or more first symbols. The method 1600 further includes receiving the UL transmission in the UL subband from another UE or transmitting the DL transmission in the DL subband to the another UE in the same symbol of the one or more first symbols.

In certain aspects, a value of the limit is less than or equal to the number of switching points, and the number of switching points is configured by a network entity or based on a rule.

In certain aspects, one or more values of the limit are based on one or more values of a subcarrier spacing (SCS). In certain aspects, a first value of the limit is for a first value of the SCS and a second value of the limit is for a second value of the SCS; the first value of the limit is different than the second value of the limit; and the first value of the SCS is different than the second value of the SCS.

In certain aspects, one or more values of the limit are based on one or more values of a frequency range (FR). In certain aspects, a first value of the limit is for a first FR and a second value of the limit is for a second FR; the first value of the limit is different than the second value of the limit; and the first FR is different than the second FR.

In one aspect, the method 1600, or any aspect related to it, may be performed by an apparatus, such as a communications device 1800 of FIG. 18, which includes various components operable, configured, or adapted to perform the method 1600. The communications device 1800 is described below in further detail.

Note that FIG. 16 is just one example of a method, and other methods including fewer, additional, or alternative steps are possible consistent with this disclosure.

### Example Communications Devices

FIG. 17 depicts aspects of an example communications device 1700. In some aspects, communications device 1700 is a user equipment (UE), such as UE 104 described above with respect to FIG. 1 and FIG. 3.

The communications device 1700 includes a processing system 1705 coupled to the transceiver 1745 (e.g., a transmitter and/or a receiver). The transceiver 1745 is configured to transmit and receive signals for the communications device 1700 via the antenna 1750, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1725 via a bus 1740. In certain aspects, the computer-readable medium/memory 1725 is configured to store instructions (e.g., computer-executable code) that when executed by the one or more processors 1710, cause the one or more processors 1710 to perform the method 1500 described with respect to FIG. 15, and/or any aspect related to it. Note that reference to a processor performing a function of communications device 1700 may include one or more processors 1710 performing that function of communications device 1700.

In the depicted example, computer-readable medium/memory 1725 stores code (e.g., executable instructions), such as code for determining 1730 and code for performing 1735. Processing of the code for determining 1730 and code for performing 1735 may cause the communications device 1700 to perform the method 1500 described with respect to FIG. 15, and/or any aspect related to it.

The one or more processors 1710 include circuitry configured to implement (e.g., execute) the code stored in the computer-readable medium/memory 1725, including circuitry such as circuitry for determining 1715 and circuitry for performing 1720. Processing with circuitry for determining 1715 and circuitry for performing 1720 may cause the communications device 1700 to perform the method 1500 described with respect to FIG. 15, and/or any aspect related to it.

Various components of the communications device 1700 may provide means for performing the method 1500 described with respect to FIG. 15, and/or any aspect related to it. For example, means for transmitting, sending or outputting for transmission may include transceivers 354 and/or antenna(s) 352 of the UE 104 illustrated in FIG. 3 and/or the transceiver 1745 and the antenna 1750 of the communications device 1700 in FIG. 17. Means for receiving or obtaining may include transceivers 354 and/or antenna(s) 352 of the UE 104 illustrated in FIG. 3 and/or the transceiver 1745 and the antenna 1750 of the communications device 1700 in FIG. 17.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 17 is an example, and many other examples and configurations of communication device 1700 are possible.

FIG. 18 depicts aspects of an example communications device 1800. In some aspects, communications device 1800 is a network entity, such as BS 102 of FIG. 1 and FIG. 3, or a disaggregated base station as discussed with respect to FIG. 2.

The communications device 1800 includes a processing system 1805 coupled to the transceiver 1855 (e.g., a transmitter and/or a receiver) and/or a network interface 1865. The transceiver 1855 is configured to transmit and receive signals for the communications device 1800 via the antenna 1860, such as the various signals as described herein. The network interface 1865 is configured to obtain and send signals for the communications device 1800 via communication link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, cause the one or more processors 1810 to perform the method 1600 described with respect to FIG. 16, or any aspect related to it. Note that reference to a processor of communications device 1800 performing a function may include one or more processors 1810 of communications device 1800 performing that function.

In the depicted example, the computer-readable medium/memory 1830 stores code (e.g., executable instructions), such as code for determining 1835 and code for transmitting 1840. Processing of the code for determining 1835 and code for transmitting 1840 may cause the communications device 1800 to perform the method 1600 described with respect to FIG. 16, or any aspect related to it.

The one or more processors 1810 include circuitry configured to implement (e.g., execute) the code stored in the computer-readable medium/memory 1830, including circuitry such as circuitry for determining 1815 and circuitry for transmitting 1820. Processing with circuitry for determining 1815 and circuitry for transmitting 1820 may cause the communications device 1800 to perform the method 1600 described with respect to FIG. 16, or any aspect related to it.

Various components of the communications device 1800 may provide means for performing the method 1600 described with respect to FIG. 16, or any aspect related to it. Means for transmitting, sending or outputting for transmission may include transceivers 332 and/or antenna(s) 334 of the BS 102 illustrated in FIG. 3 and/or the circuitry for transmitting 1820, the code for transmitting 1840, the transceiver 1855 and the antenna 1860 of the communications device 1800 in FIG. 18. Means for receiving or obtaining may include transceivers 332 and/or antenna(s) 334 of the BS 102 illustrated in FIG. 3 and/or the transceiver 1855 and the antenna 1860 of the communications device 1800 in FIG. 18.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 18 is an example, and many other examples and configurations of communication device 1800 are possible.

### Example Clauses

Implementation examples are described in the following numbered clauses:

Clause 1: A method for wireless communications at a user equipment (UE), comprising: determining a limit on a number of switching points between one or more first symbols configured for sub-band full duplex (SBFD) communications and one or more second symbols configured for non-SBFD communications, within a period of time; determining a configuration for the SBFD communications based on the limit; and performing the SBFD communications, in accordance with the configuration.

Clause 2: The method of clause 1, further comprising transmitting an indication of the limit to a network entity.

Clause 3: The method of clause 2, wherein the determining the configuration further comprises receiving the configuration from the network entity.

Clause 4: The method of clause 3, further comprising transmitting an indication of invalid configuration when a value of the limit is more than the number of switching points, and wherein the number of switching points is configured by the network entity or based on a rule.

Clause 5: The method of clause 4, further comprising dropping the configuration when the configuration is invalid.

Clause 6: The method of any one of clauses 1-5, wherein the one or more first symbols support subband frequency duplexing for simultaneous uplink (UL) and downlink (DL) transmissions.

Clause 7: The method of any one of clauses 1-6, wherein the period of time is associated with: a slot, a time division duplex (TDD) uplink (UL) and downlink (DL) pattern period, or a semi-static SBFD configuration period.

Clause 8: The method of clause 7, wherein the TDD UL and DL pattern period is different than the semi-static SBFD configuration period.

Clause 9: The method of clause 8, further comprising transmitting an indication of a maximum value or a minimum value of at least one of: the limit on the number of switching points between the one or more first symbols and the one or more second symbols within the semi-static SBFD configuration period or the limit on the number of switching points between the one or more first symbols and the one or more second symbols within the TDD pattern period.

Clause 10: The method of any one of clauses 1-9, wherein: a value of the limit is less than or equal to the number of switching points, and the number of switching points is configured by a network entity or based on a rule.

Clause 11: The method of any one of clauses 1-10, wherein a value of the limit is equal to one.

Clause 12: The method of any one of clauses 1-11, wherein a value of the limit is equal to two.

Clause 13: The method of any one of clauses 1-12, wherein one or more values of the limit are based on one or more values of a subcarrier spacing (SCS).

Clause 14: The method of clause 13, wherein: a first value of the limit is for a first value of the SCS and a second value of the limit is for a second value of the SCS; the first value of the limit is different than the second value of the limit; and the first value of the SCS is different than the second value of the SCS.

Clause 15: The method of any one of clauses 1-14, wherein one or more values of the limit are based on one or more values of a frequency range (FR).

Clause 16: The method of clause 15, wherein: a first value of the limit is for a first FR and a second value of the limit is for a second FR; the first value of the limit is different than the second value of the limit; and the first FR is different than the second FR.

Clause 17: The method of any one of clauses 1-16, further comprising transmitting reference capability indicating a reference value corresponding to the limit per frequency range (FR), wherein one or more values of the limit for one or more values of a subcarrier spacing (SCS) is based on the reference value.

Clause 18. A method for wireless communications at a network entity, comprising: determining a limit on a number of switching points between one or more first symbols configured for sub-band full duplex (SBFD) communications and one or more second symbols configured for non-SBFD communications, within a period of time; and transmitting a configuration for the SBFD communications based on the determination.

Clause 19: The method of clause 18, wherein the period of time is associated with: a slot, a time division duplex (TDD) uplink (UL) and downlink (DL) pattern period, or a semi-static SBFD configuration period.

Clause 20: The method of any one of clauses 18-19, wherein: the determining further comprises receiving capability information from a user equipment (UE), and the capability information comprises the limit on the number of switching points.

Clause 21: The method of any one of clauses 18-20, wherein the determining further comprises determining the limit on the number of switching points based on a rule.

Clause 22: The method of any one of clauses 18-21, wherein a value of the limit is equal to one or two.

Clause 23: The method of any one of clauses 18-22, wherein: the one or more first symbols support subband frequency duplexing for simultaneous uplink (UL) and downlink (DL) transmissions, transmitting a DL transmission in a DL subband to a user equipment (UE) or receiving an UL transmission in a UL subband from the UE in a same symbol of the one or more first symbols, and receiving the UL transmission in the UL subband from another UE or transmitting the DL transmission in the DL subband to the another UE in the same symbol of the one or more first symbols.

Clause 24: The method of any one of clauses 18-23, wherein: a value of the limit is less than or equal to the number of switching points, and the number of switching points is configured by a network entity or based on a rule.

Clause 25: The method of any one of clauses 18-24, wherein one or more values of the limit are based on one or more values of a subcarrier spacing (SCS).

Clause 26: The method of clause 25, wherein: a first value of the limit is for a first value of the SCS and a second value of the limit is for a second value of the SCS; the first value of the limit is different than the second value of the limit; and the first value of the SCS is different than the second value of the SCS.

Clause 27: The method of any one of clauses 18-26, wherein one or more values of the limit are based on one or more values of a frequency range (FR).

Clause 28: The method of clause 27, wherein: a first value of the limit is for a first FR and a second value of the limit is for a second FR; the first value of the limit is different than the second value of the limit; and the first FR is different than the second FR.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
a memory comprising instructions; and
at least one processor configured to execute the instructions and cause the apparatus to:
determine a limit on a number of switching points between one or more first symbols configured for sub-band full duplex (SBFD) communications and one or more second symbols configured for non-SBFD communications, within a period of time;
determine a configuration for the SBFD communications based on the limit; and
perform the SBFD communications, in accordance with the configuration.

2. The apparatus of claim 1, wherein the at least one processor is configured to execute the instructions and cause the apparatus to transmit an indication of the limit to a network entity.

3. The apparatus of claim 2, wherein the at least one processor is configured to execute the instructions and cause the apparatus to receive the configuration from the network entity.

4. The apparatus of claim 3, wherein:
the at least one processor is configured to execute the instructions and cause the apparatus to transmit an indication of invalid configuration when a value of the limit is more than the number of switching points; and
the number of switching points is configured by the network entity or based on a rule.

5. The apparatus of claim 4, wherein the at least one processor is configured to execute the instructions and cause the apparatus to drop the configuration when the configuration is invalid.

6. The apparatus of claim 1, wherein the one or more first symbols support subband frequency duplexing for simultaneous uplink (UL) and downlink (DL) transmissions.

7. The apparatus of claim 1, wherein the period of time is associated with:
a slot;
a time division duplex (TDD) uplink (UL) and downlink (DL) pattern period; or
a semi-static SBFD configuration period.

8. The apparatus of claim 7, wherein the TDD UL and DL pattern period is different than the semi-static SBFD configuration period.

9. The apparatus of claim 8, wherein the at least one processor is configured to execute the instructions and cause the apparatus to transmit an indication of a maximum value or a minimum value of at least one of: the limit on the number of switching points between the one or more first symbols and the one or more second symbols within the semi-static SBFD configuration period or the limit on the number of switching points between the one or more first symbols and the one or more second symbols within the TDD pattern period.

10. The apparatus of claim 1, wherein:
a value of the limit is less than or equal to the number of switching points; and
the number of switching points is configured by a network entity or based on a rule.

11. The apparatus of claim 1, wherein a value of the limit is equal to one.

12. The apparatus of claim 1, wherein a value of the limit is equal to two.

13. The apparatus of claim 1, wherein one or more values of the limit are based on one or more values of a subcarrier spacing (SCS).

14. The apparatus of claim 13, wherein:
a first value of the limit is for a first value of the SCS and a second value of the limit is for a second value of the SCS;
the first value of the limit is different than the second value of the limit; and
the first value of the SCS is different than the second value of the SCS.

15. The apparatus of claim 1, wherein one or more values of the limit are based on one or more values of a frequency range (FR).

16. The apparatus of claim 15, wherein:
a first value of the limit is for a first FR and a second value of the limit is for a second FR;
the first value of the limit is different than the second value of the limit; and
the first FR is different than the second FR.

17. The apparatus of claim 1, wherein:
the at least one processor is configured to execute the instructions and cause the apparatus to transmit reference capability indicating a reference value corresponding to the limit per frequency range (FR); and
one or more values of the limit for one or more values of a subcarrier spacing (SCS) are based on the reference value.

18. An apparatus for wireless communications at a network entity, comprising:
a memory comprising instructions; and
at least one processor configured to execute the instructions and cause the apparatus to:
determine a limit on a number of switching points between one or more first symbols configured for sub-band full duplex (SBFD) communications and one or more second symbols configured for non-SBFD communications, within a period of time; and
transmit a configuration for the SBFD communications based on the determination.

19. The apparatus of claim 18, wherein the period of time is associated with:
a slot;
a time division duplex (TDD) uplink (UL) and downlink (DL) pattern period; or
a semi-static SBFD configuration period.

20. The apparatus of claim 18, wherein:
the at least one processor is configured to execute the instructions and cause the apparatus to receive capability information from a user equipment (UE); and
the capability information comprises the limit on the number of switching points.

21. The apparatus of claim 18, wherein the at least one processor is configured to execute the instructions and cause the apparatus to determine the limit on the number of switching points based on a rule.

22. The apparatus of claim 18, wherein a value of the limit is equal to one or two.

23. The apparatus of claim 18, wherein:
the one or more first symbols support subband frequency duplexing for simultaneous uplink (UL) and downlink (DL) transmissions; and
the at least one processor is configured to execute the instructions and cause the apparatus to:
transmit a DL transmission in a DL subband to a user equipment (UE) or receiving an UL transmission in a UL subband from the UE in a same symbol of the one or more first symbols, and
receive the UL transmission in the UL subband from another UE or transmitting the DL transmission in the DL subband to the another UE in the same symbol of the one or more first symbols.

24. The apparatus of claim 18, wherein:
a value of the limit is less than or equal to the number of switching points; and
the number of switching points is configured by a network entity or based on a rule.

25. The apparatus of claim 18, wherein one or more values of the limit are based on one or more values of a subcarrier spacing (SCS).

26. The apparatus of claim 25, wherein:
a first value of the limit is for a first value of the SCS and a second value of the limit is for a second value of the SCS;
the first value of the limit is different than the second value of the limit; and
the first value of the SCS is different than the second value of the SCS.

27. The apparatus of claim 18, wherein one or more values of the limit are based on one or more values of a frequency range (FR).

28. The apparatus of claim 27, wherein:
a first value of the limit is for a first FR and a second value of the limit is for a second FR;
the first value of the limit is different than the second value of the limit; and
the first FR is different than the second FR.

29. A method for wireless communications at a user equipment (UE), comprising:
determining a limit on a number of switching points between one or more first symbols configured for sub-band full duplex (SBFD) communications and one or more second symbols configured for non-SBFD communications, within a period of time;
determining a configuration for the SBFD communications based on the limit; and
performing the SBFD communications, in accordance with the configuration.

30. A method for wireless communications at a network entity, comprising:
determining a limit on a number of switching points between one or more first symbols configured for sub-band full duplex (SBFD) communications and one or more second symbols configured for non-SBFD communications, within a period of time; and
transmitting a configuration for the SBFD communications based on the determination.
